(19) United States
(12) Patent Application Publication
(10) Pub. No.: US 2012/0031383 A1
(43) Pub. Date: Feb. 9, 2012

(54) INTERNAL COMBUSTION ENGINE

(75) Inventor: Ralf Stockhausen, Gladbeck (DE)

(73) Assignee: WILLI FECHNER GMBH, Gelsenkirchen (DE)

(21) Appl. No.: 13/263,784

(22) PCT Filed: Apr. 9, 2010
(86) PCT No.: PCT/EP10/02221

§ 371 Date: Oct. 10, 2011

(30) Foreign Application Priority Data
Apr. 9, 2009 (DE) 10 2009 016 813.3
May 4, 2009 (DE) 10 2009 019 464.9
Jun. 18, 2009 (DE) 10 2009 029 808.8

(51) Int. Cl. F02B 33/22; F02B 33/06

(52) U.S. Cl. 123/70 R

(57) ABSTRACT

An internal combustion engine with a crankshaft, at least one compression piston which is housed in a compression cylinder, and at least one working piston which is housed in a working cylinder. Movement of the compression piston and of the working piston are coupled kinematically to movement of the crankshaft, so that the compression piston moves back and forth during a single revolution of the crankshaft in an intake stroke and a compression stroke and that the working piston moves back and forth during a single revolution of the crankshaft by a working stroke and an exhaust stroke. The compression cylinder has at least one inlet valve for drawing-in air into the compression cylinder during downward movement of the compression piston, and the working cylinder has at least one outlet valve for discharging combustion gases from the working cylinder during upward movement of the working piston.

### BACKGROUND OF THE INVENTION

1. Field of the Invention

The invention relates to an internal combustion engine with a crankshaft, at least one movable compression piston housed in a compression cylinder and at least one movable working piston housed in an operating cylinder, wherein the movement of the compression piston and the movement of the working piston are kinematically coupled to the movement of the crankshaft, so that, during a single revolution of the crankshaft by an intake stroke and a compression stroke of a four-stroke cycle, the compression piston moves back and forth and that the working piston moves back and forth during a single revolution of the crankshaft by a working stroke and an exhaust stroke of the same four-stroke cycle, wherein the compression cylinder has at least one inlet valve for drawing-in air into the compression cylinder with a downward movement of the compression piston and the working cylinder has at least one outlet valve for purging out combustion gases in an upward motion of the working piston.

2. Description of Related Art

As internal combustion engines for driving motor vehicles, machines and the like, at present, almost exclusively use reciprocating piston engines that operate on the Otto or Diesel principle. The deficiencies of these engines, including unsatisfactory efficiency, high emissions, especially during cold starts, considerable noise and the like are known and are largely attributed to the fact that the transformation of liquid fuel into the gaseous state, the mixture formation, ignition and combustion of all take place within a very small, short operating cycle under strongly varying and poor controllable flow conditions.

German document DE 602 25 451 T2 and corresponding U.S. Pat. Nos. 6,543,225 B2 and 6,609,371 B2 disclose a motor, which has a crankshaft that revolves around a crankshaft axis of the engine. In addition, a piston is provided which is housed within a first cylinder that can be moved and operatively connected to the crankshaft, so that the working piston moves back and forth during a single revolution of the crankshaft by a working stroke and an exhaust stroke of a four-stroke cycle. Also, a movable compression piston is provided which is housed within a second cylinder and operationally connected to the crankshaft, so that the compression piston moves back and forth during the same revolution of the crankshaft by an intake stroke and a compression stroke of the same four-stroke cycle. The first and second cylinders are connected to each other via a gas passage, wherein the gas passage contains an inlet valve and an outlet valve defining a pressure chamber in between, wherein the inlet valve and the outlet valve of the gas passage maintain essentially at least one specified ignition-state gas pressure in the pressure chamber during the entire four-stroke cycle. In order to reach the ignition position of the piston, the crankshaft must revolve at least by 20° from a position in which the working piston is located in its upper dead-point position. The ignition position is thus achieved only when the working piston is moving downward and has reached a specified distance from the upper dead center. The engine as known from prior art also has an unsatisfactory efficiency that is attributed to higher emissions.

### SUMMARY OF THE INVENTION

The object of the present invention is to provide an internal combustion engine, which is distinguished from other engines as known from prior art by a higher efficiency, a good torque response, a low pollutant emission and low manufacturing and operating costs.

The aforementioned object is achieved in an internal combustion engine of the type mentioned above that has at least two combustion chambers that are separated from each other and interconnected with the compression cylinder and the working cylinder for igniting a fuel-air mixture, in accordance with a first alternative embodiment of the invention, by each combustion chamber being connected to the compression cylinder via at least one combustion chamber inlet valve and to the working cylinder via a combustion chamber outlet valve, and wherein the valves are so controlled that the outlet valve of the combustion chamber is opened only after combustion of the fuel-air mixture in the combustion chamber and that the combustion chambers are controlled alternately for combustion.

The invention relates to a reciprocating internal combustion engine, wherein the intake as well as the compression process is performed by at least one compression piston and the operating and pushing process of at least one working piston. The two pistons are arranged opposite each other. Between the working cylinder and the compression cylinder there is a connection via at least two combustion chambers located in the cylinder head, wherein the fuel-air mixture is brought to combustion, which can happen due to external or self-ignition (diesel fuel/biodiesel). The two combustion chambers are alternately activated only every second revolution, so that sufficient time is available for preparing the fuel and air mixture for combustion in the combustion chamber. Accordingly, the control of the valves is set, wherein upon combustion of a fuel-air mixture in the combustion chamber, the same combustion chamber is controlled only after a 720° revolution of the crankshaft and a fresh fuel-air mixture is burned in the combustion chamber again. The alternate combustion in at least two combustion chambers ensures a substantially complete combustion of the fuel-air mixture and contributes to low exhaust emissions. As a result, the internal combustion engine is distinguished by a higher efficiency than that of the engines as known from the prior art and the manufacturing and operating costs are low.

In principle, the combustion chambers can have an equal size. At least two pairs of combustion chambers can also be provided, each with two combustion chamber pairs of equal size, wherein the combustion chambers of a first combustion chambers pair can be larger than the combustion chamber pair of a second combustion chamber pair, and wherein both combustion chambers of a combustion chamber pair, i.e., equal-sized combustion chambers, are alternately controlled for combustion. At low speeds in city traffic, if the cylinders have a lower degree of filling, a combustion chamber pair can be controlled with smaller combustion chambers, and thus, the combustion efficiency can be increased. However, for faster travel, and maximum cylinder filling, the combustion chamber pair can be controlled with the larger combustion chambers. This can improve fuel utilization and ensures high combustion efficiency. The combustion takes place alternately in each case in the same size combustion chambers.

In another embodiment of the invention, it may be provided that at least two combustion chamber pairs are provided with two combustion chambers of different sizes, wherein each of the two combustion chambers of different sizes belonging to a combustion chamber pair can be controlled together for combustion and wherein the combustion chamber pairs are controlled alternately. Again, it is preferably such that the combustion chamber pairs each have equally large total combustion chamber volume, whereby the total combustion chamber volume comprises of the volumes of the combustion chambers of different sizes allotted to one pair of combustion chambers. The total volume of the larger combustion chamber and the smaller combustion chamber of a combustion chamber pair can be designed for a maximum cylinder filling. For example, one large and one small combustion chamber can form a pair of combustion chambers and are each controlled at the same time for combustion. In the next revolution of the crankshaft, a larger combustion chamber and a smaller combustion chamber of an additional combustion chamber pair are controlled for combustion. In this context, the larger combustion chamber can be approximately twice as large as the smaller combustion chamber. However, other proportions in size are possible in principle.

The control and/or opening and closing of the valves can be done electrically, pneumatically, mechanically or hydraulically. It can also be provided with automatic valves, actuated by the prevailing gas pressure in the cylinder, known as flapper valves.

The control of the valves can provide the opening of the combustion chamber outlet valve during revolution of the crankshaft by less than 20°, preferably less than 10°, especially less than 5°, via a position beyond that in which the working piston is located in its upper dead-point position. Preferably, the combustion chamber outlet valve is opened when the working piston is located directly in the upper dead center, with a deviation of ±1° to 4° with reference to the revolution of the crankshaft. When opening the outlet valve of the combustion chamber, the combustion of the fuel-air mixture is completed in the combustion chamber or essentially completed and the combustion process is concluded. The burned mixture is then passed through the opening of the combustion chamber outlet valve of the controlled combustion chamber into the working cylinder.

From the viewpoint of structural design, the kinematic coupling of the motion of compression piston and working piston to the crankshaft is preferably designed such that the compression piston and the working piston, in the case of a four stroke cycle, during the movement from the respective top dead center to the bottom dead center and back, execute a continuous counter-movement. In a preferred manner, the compression cylinder and the working cylinder side are arranged by side in a plane transverse to the longitudinal axis of the crankshaft, in particular perpendicular to the longitudinal axis of the crankshaft. This leads to a space-saving design of the engine and allows a kinematic coupling of the motion of compression piston and working piston with low friction losses, which will be discussed below.

In order to solve the above problem, it may be provided, in an internal combustion engine of in above mentioned type, in an alternative embodiment according to the invention, that the working piston is articulately connected with the crankshaft via a multi-part link rod, wherein the link rod has at least two connecting rods, and the connecting rods are connected at the end via at least one first hinge, while the other end of a first connecting rod of the link rod is flexibly connected with the working piston and the other end of a second connecting rod of the link rod is flexibly connected with the crankshaft, namely with a crank pin of the crankshaft, wherein a cross connecting rod is articulated at the end on the first hinge, wherein the cross connecting rod is type of a pivot rod that rotates about a pivot axis, wherein the other end of the cross connecting rod is flexibly connected via at least a second hinge with at least a third connecting rod, the third connecting rod being articulately connected with the compression piston.

Thanks to the proposed kinematic coupling of compression pistons, working pistons and crankshaft, the friction forces on the cylinder walls can be reduced in the upward and downward movement of the pistons, resulting in an improved power transmission to the crankshaft, and thus, to an increase in torque. By the division of the link rod under the working piston, an improved application of force is achieved in the revolution of the crankshaft, wherein the pressure across the working piston can be utilized almost without any loss of compression as a result of the connection of the working piston with the compression piston via the cross connecting rod. In the case of the noted articulated connection of the working piston and the compression piston with the crankshaft, less energy must be drawn from revolution so as to cause the compression via the compression piston. Here, the residual energy of the burned gases is further utilized in the working cylinder before the working piston reaches the bottom dead center, in order to move the compression piston upward. In the case of the engines as known from the prior art, this residual energy is lost with the compression of burned gas in the exhaust system. The aforesaid crank mechanism of the internal combustion engine contributes to a higher efficiency, better torque performance and lower emissions, coupled with low manufacturing and operating costs.

In another alternative embodiment of the internal combustion engine for solving the above-mentioned object, it may be provided that at least two separate compression chambers interconnecting the compression cylinder and the working cylinder are provided for the purpose of compressing air, or a fuel-air mixture, or for retaining the air compressed in the compression cylinder or for retaining a compressed fuel-air mixture, wherein the ignition and combustion of the fuel-air mixture can be carried out in the working cylinder, wherein each compression chamber is connected to the compression cylinder via at least one compression chamber inlet valve and wherein the at least one working cylinder and the valves are controlled such that the compression chambers are alternately controlled for compression.

This embodiment of the invention again relates to a reciprocating internal combustion engine, wherein the intake and compression process can be performed in a compression cylinder with a compression piston and the operating and compression process in an operating cylinder with piston. Preferably, the two cylinder-piston assemblies are arranged opposite each other, as has been described above. Between the compression cylinder and the working cylinder there exists a connection via at least two compression chambers located in the cylinder head, in which the drawn-in air through the compression piston is pushed during the compression stroke. In the compression chamber, the air may be treated as a gas mixture for combustion, or only when it has been “discharged” in the working cylinder, via the working piston. It is first ignited only in the working cylinder, depending upon the fuel by self-ignition or external ignition. The internal combustion engine with two compression chambers leads to a higher efficiency in fuel combustion, to a better torque performance and to a reduced emission of polluting substances, combined with low production and operating costs.

In a further preferred embodiment, the control of the valves can provide for the opening of the compression chamber outlet valve during revolution of the crankshaft by more than 340° to 360°, preferably provide more than 350° to 360°, preferably more than 355° to 360°, wherein the working piston is located in its upper dead-point position during revolution of the crankshaft by 360°. Preferably, the introduction of compressed air and/or compressed air-fuel mixture is done immediately before the working piston has reached its top dead center point. The introduction of pressure from a compression chamber in the working cylinder starts before reaching a 360° crankshaft revolution. The compression chamber outlet valve closes, preferably before it comes to ignition and combustion of the fuel-air mixture in the working cylinder. It is essential that the two compression chambers are controlled alternately, i.e., at every second turn, thus it has been described above in connection with said embodiment of an internal combustion engine with two combustion chambers.

The compression chambers may be of equal size. There may also be at least two different compression chamber pairs, each with two compression chambers of equal size, wherein the compression chambers of a first compression chamber pair are greater than the compression chambers of a second compression chamber pair and in each case the same two compression chambers of a compression chamber pair can be controlled alternately for compression. It is also possible that at least two compression chamber pairs are provided, each with at least two compression chambers of different size, wherein each of the two different sized compression chambers of a compression chamber pair can be controlled together for compression and wherein the compression chamber pairs are controlled alternately.

The temperature of combustion air and/or fuel-air mixture can be favorably influenced using water, distilled water or mixtures thereof, together with alcohol and if necessary, other components. In this context, a fourth alternative embodiment of the invention for solving the object mentioned is provided with at least one device for injecting water and/or distilled water and/or alcohol and/or a mixture of water and alcohol and if necessary, other substances into the compression cylinder and/or into a combustion chamber interconnecting the working cylinder and the compression cylinder and/or into a compression chamber interconnecting the working cylinder and the compression cylinder and/or an intake of the compression cylinder. Due to the provision of a sufficiently high water content in the fuel-air mixturem self-ignition can be precluded during compression of the gas mixture.

Another aspect of the invention relates to a method for operating an internal combustion engine of the type described above based on the method steps as illustrated in the drawings.

The aforementioned aspects and features of the present invention and the aspects described in the following and the features of the present invention can be used independently, and also in any combination.

Further advantages, features, characteristics and aspects of the present invention will become apparent from the following description of preferred embodiments with reference to the accompanying drawings.

### BRIEF DESCRIPTION OF THE DRAWINGS

FIG. 1 is a schematic cross-sectional view of a first embodiment of an inventive internal combustion engine with two combustion chambers, with valves of the combustion chambers are arranged essentially parallel to the cylinder axes,

FIG. 2 is a schematic top plan view of a second embodiment of an internal combustion engine with four combustion chambers, wherein the valves of the combustion chambers are arranged essentially perpendicular to the cylinder axis,

FIGS. 3a to 3f are schematic representations of the four-stroke cycle internal combustion engine as shown in FIG. 1 during operation of the internal combustion engine,

FIG. 4 is a schematic cross-sectional view of a third embodiment of an internal combustion engine with two compression chambers, wherein the valves of the compression chambers are arranged essentially parallel to the cylinder axes,

FIG. 5 is a schematic top plan view of a fourth embodiment of an internal combustion engine with two compression chambers, wherein the valves of the compression chambers are arranged essentially perpendicular to the cylinder axis,

FIG. 6 is a schematic cross-sectional view of a fifth embodiment of an internal combustion engine with two compression chambers and at least one combustion chamber in the working piston,

FIG. 7 is a schematic cross-sectional view of a sixth embodiment of an internal combustion engine with two compression chambers and having at least one combustion chamber in the working piston, and

FIGS. 8 to 10 are perspective views of further embodiments of an internal combustion engine, wherein the working piston is flexibly attached to the crankshaft via a multi-part link rod.

### DETAILED DESCRIPTION OF THE INVENTION

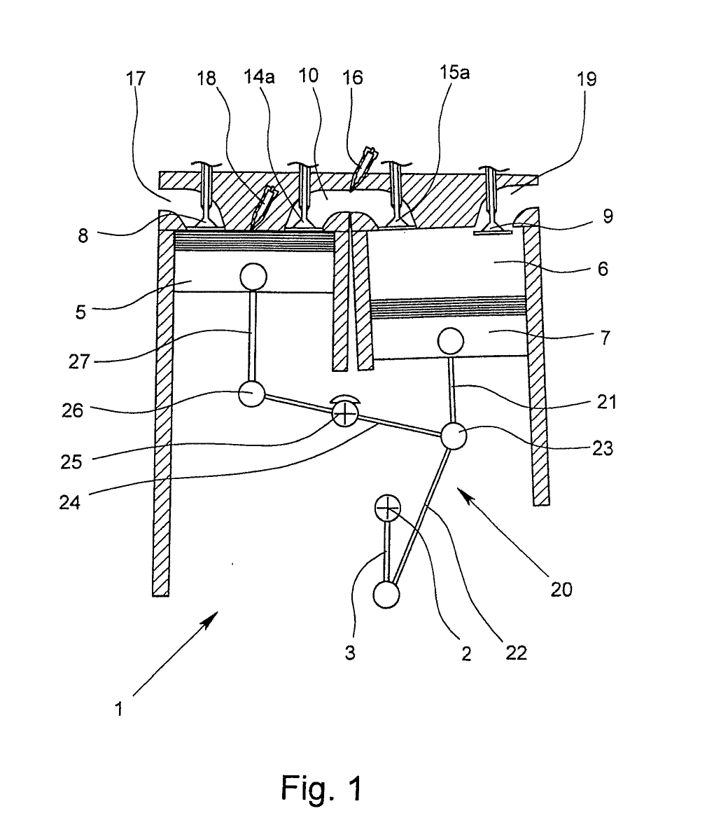

FIG. 1 shows an internal combustion engine 1 in a schematic cross-sectional view. The internal combustion engine 1 has a crankshaft, which is not shown in detail. However, the longitudinal axis 2 of the crankshaft is shown, by which a crank arm 3 revolves during operation of internal combustion engine 1. The internal combustion engine 1 has a compression pistons 5 that can be freely moved in an operating cylinder 6 and a working piston 7 that can be freely moved in a compression cylinder 4, wherein the movement of the compression piston 5 and the movement of the working piston 7 are kinematically coupled to the movement of the crankshaft so that the compression piston 5 moves back and forth during a single revolution of the crankshaft in an intake stroke and a compression stroke of a four-stroke cycle and the working piston 7 moves back and forth during a single revolution of the crankshaft in an operating stroke and an exhaust stroke of the same four-stroke cycle. The compression cylinder 4 has at least two inlet valves 8 for drawing-in air into the compression cylinder 4 during a downward movement of the compression piston and the working cylinder 7, and two outlet valves 9 for emitting combustion gases from the working cylinder 6 during an upward movement of the working piston 7. The inlet valves 8 and the outlet valves 9 are arranged perpendicular to the cylinder axis of compression cylinder 4 and the working cylinder 6.

In order to obtain adequate time for preparation of a fuel-air mixture and combustion of the fuel-air mixture, at least two, preferably four, separated from one another, combustion chambers 10-13 having the compression cylinder 4 interconnected with the working cylinder 6 are provided for ignition and combustion of fuel-air mixture. This is illustrated in FIGS. 1 to 3. Each of the combustion chambers 10-13 is connected via at least one combustion chamber inlet valve 14a-14d with the compression cylinder 4 and is also connected with the working cylinder 6 via at least one combustion chamber outlet valve 15a-15d. The valves 8, 9, 14a-14d, 15a-15d are controlled such that the combustion chamber outlet valve 15a-5d of a combustion chamber 10-13 is opened only after the combustion of the fuel-air mixture in combustion chambers 10-13 and that the combustion chambers 10-13 are alternately controlled for combustion. Thus, essentially complete combustion of the fuel in the combustion chambers 10-13 is guaranteed, resulting in a higher efficiency and a low-emission of pollutants from the internal combustion engine 1. FIG. 1 shows only one combustion chamber 10 with a combustion chamber inlet valve 14a and a chamber outlet valve 15a. The combustion chamber valves 14a, 15a are arranged parallel to the longitudinal axes of the compression cylinder 4 and the working cylinder 6.

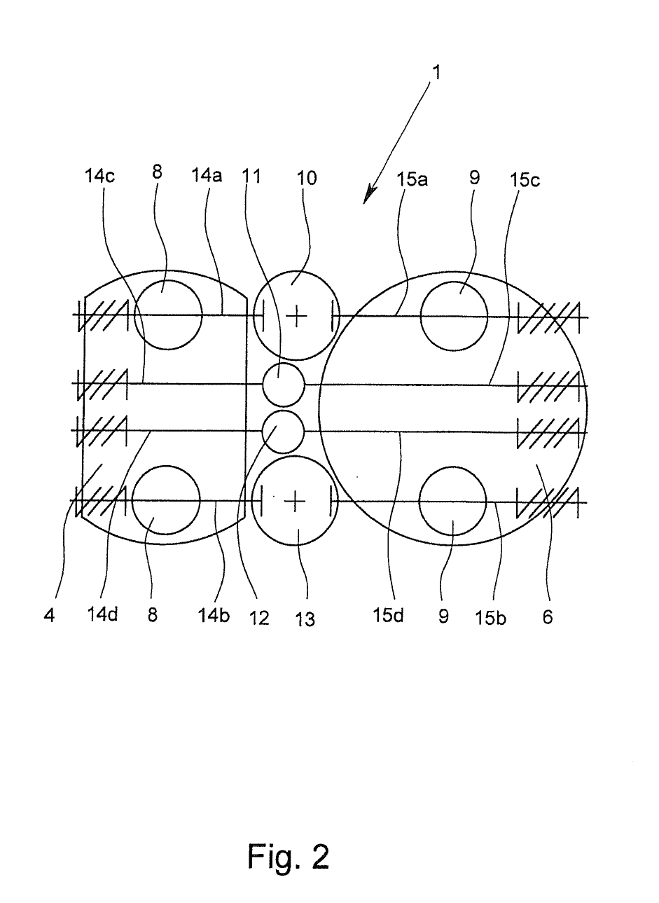

FIG. 2 shows a second embodiment of an internal combustion engine 1 having four combustion chambers 10-13, wherein the combustion chamber inlet valves 14a-14d, and the combustion chamber outlet valves 15a-15d are arranged perpendicular to the longitudinal axis of the compression cylinder 4, and perpendicular to the longitudinal axis of the working cylinder 6. In doing so, the combustion of the fuel in the combustion chambers 10-13 is least disturbed by the valves 14a-14d, 15a-15d. However, basically, it is also possible that the combustion chamber inlet valves 14a-14d and/or the combustion chamber outlet valves 15a-15d are arranged parallel to the longitudinal axis of the compression cylinder 4 and/or to the longitudinal axis of the working cylinder 6 as represented in FIG. 1.

As is evident from FIG. 2, the combustion chambers 10 and 13 have a larger combustion chamber volume than the combustion chambers 11 and 12. At low speed in city traffic, when the cylinders have a lower degree of filling, the smaller combustion chambers 11, 12 are controlled alternately, thereby increasing the efficiency of combustion. However, for maximum cylinder filling, the larger combustion chambers 10, 13 are controlled alternately. In principle, it is also possible that the size of the combustion chambers 10-13 is so chosen that the combustion chamber volume of the larger combustion chambers 10, 13, is approximately twice as large as the volume of the smaller combustion chambers 11, 12. The total combustion chamber volume of a larger combustion chamber 10, 13 and a smaller combustion chamber 11, 12 may then be sufficient for a maximum cylinder filling. Then, for example, the combustion chambers 10 and 11 and the combustion chambers 12 and 13 can be actuated simultaneously. It is understood that the invention is not restricted to the proportions in size as shown in FIG. 2.

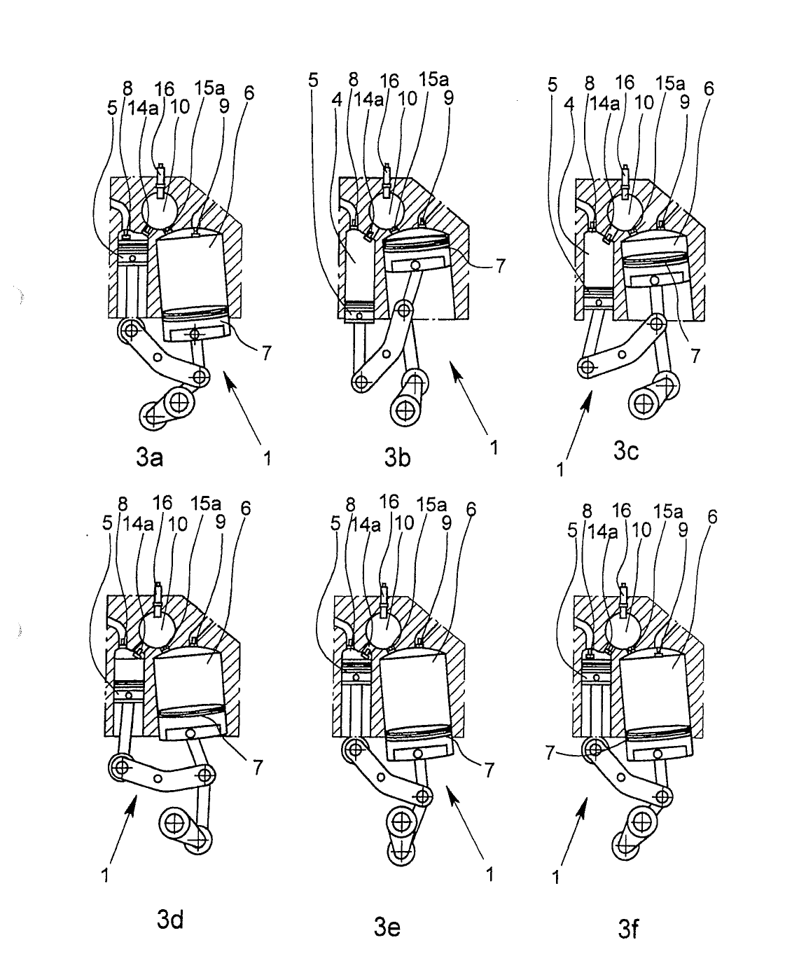

The functioning of the internal combustion engine 1 is described in detail in the following. Air is drawn-in through the open inlet valve 8 during the downward movement of the compression piston 5 in the compression cylinder 4. Inlet valves 8 close at the bottom dead center of the compression piston 5 and the combustion chamber inlet valve 14a of the first combustion chamber 10 opens. This is shown schematically in FIGS. 3a and 3b.

During upward movement of the compression piston 5 (see, FIGS. 3c-3f), the drawn-in air is compressed in the first combustion chamber 10, at which the combustion chamber outlet valve 15a is closed first. Upon the compression piston 5 reaching upper dead center, the first combustion chamber inlet valve 14a of the combustion chamber 10 closes.

If diesel or bio diesel is used as fuel, then air is prepared for combustion, wherein fuel is injected through a nozzle 16 into the combustion chamber 10, and brought to combustion through auto-ignition. If gasoline, gas, hydrogen or alcohol is used as fuel, air is pre-treated for combustion with direct injection through the nozzle 16 and then brought to combustion in the combustion chamber 10 by spark ignition using a spark plug (not shown here). If gasoline, gas, hydrogen or alcohol is used as fuel, the enrichment of air can also happen in a suction pipe or an intake channel 17 of the cylinder head. Subsequently, the compressed mixture in the combustion chamber 10 is combusted by means of spark-ignition using a spark plug. Enrichment of combustion air with fuel in the compression cylinder 4 can be done through a nozzle 18. Finally the compressed mixture in the combustion chamber 10 is brought to combustion by means of spark ignition. The air can be partially enriched in the suction pipe or in the inlet channel 17 in the cylinder head, in the compression cylinder 4 through the nozzle 18 and/or in the combustion chamber 10 through the nozzle 16. It is understood that other combustion chambers 11, 12, 13 can have corresponding nozzles 16. Then, the compressed-air mixture fuel contained in the combustion chamber 10 is brought to combustion by means of spark ignition.

Once the compression piston 5 reaches upper dead center, the working piston 7 is located at bottom dead center (ref. FIG. 3f), which means that the combustion chamber outlet valve 15a of the first combustion chamber 10 closes. Thereafter, the working piston 7 compresses the stress-relieved, burned mixture through the open outlet valve 9 from the working cylinder 6 through the outlet channel 19 of the cylinder head in the exhaust.

At the same time, the compression piston 4 is on its way to bottom dead center. Air is drawn-in through the open inlet valves 8. Once the working piston 7 reaches upper dead center, the outlet valves 9 are closed and the combusted mixture in the first combustion chamber 10 is led into working cylinder 6 through the opening of the first outlet valve 15a of the combustion chamber.

About the same time, the inlet valves 8 close, the second combustion-chamber inlet valve 14b of the second equal-sized combustion chamber 13 is opened and the previously drawn-in air or the fuel-air mixture is now compressed in the combustion chamber 13 on the path of the compression piston 5 from the bottom dead center to top dead center. Subsequently, as described above, the same takes place with respect to the combustion chamber 13. Here, the working piston 7 is located on the path from the top dead center to bottom dead center. At bottom dead center, the first chamber outlet valve 15a closes and the outlet valves 9 open, wherein the compression piston 5 is located approximately at the top dead center. Thereafter, the second chamber inlet valve 14b closes and the inlet valves 8 open.

As per FIG. 1, the compression cylinder 4 and the working cylinder 6 are arranged alongside one another in a plane perpendicular to the longitudinal axis 2 of the crankshaft.

As can be seen from FIG. 1, the working piston 5 is articulately connected with the crankshaft via a multi-part link rod 20, wherein the link connecting rod 20 has at least two connecting rods 21, 22, wherein the connecting rods 21, 22 are connected at their proximal ends via at least a first hinge 23, wherein the opposite end of the first connecting rod 21 of the link connecting rod 20 is pivotably connected with the working piston 7 and the other end of the second connecting rod 22 is pivotably connected to a crank arm 3 of the crankshaft. At the first hinge 23, an end of a cross connecting rod 24 is pivotably connected, wherein the cross connecting rod 24 a type of a rocker arm that pivots about a pivot axis 25. The cross connecting rod 24 does not necessarily have a straight shape. The other end of cross connecting rod 24 is pivotably connected via at least one second hinge 26 to at least a third connecting rod 27 which is pivotably connected to the compression piston 5. The illustrated form of the kinematic coupling of the compression piston 5, working piston 7 and crankshaft causes the compression piston 5 and the working piston 7 to move in opposite directions during the four-stroke cycle. Thanks to the connection via link connecting rod 20 and cross connecting rod 24, the compression piston 5 and the working piston 7 can be moved up and down with lower friction losses, leading to an increase in overall efficiency in fuel combustion.

It is also shown in FIG. 1, that the longitudinal axis 2 of the crankshaft is arranged below the rotational axis of the first hinge 23 and below the rotational axis of the second hinge 26. Further, the longitudinal axis 2 of the crankshaft can run below the axis of rotation 25 of the cross connecting rod 24. The longitudinal axis 2 of the crankshaft is spaced apart in a horizontal direction laterally from the rotational axis of the first hinge 23 and, preferably, arranged in the area between the pivotal axes of the first hinge 23 and the second hinge 26. This structure leads to very low friction losses, and thus, to a high degree of energy utilization during fuel combustion. In addition, it is preferably provided that the longitudinal axis 2 of the crankshaft runs in a horizontal direction in the region between the rotational axis 25 of the cross connecting rod 24 and the axis of revolution of the first hinge 23. In the horizontal direction, the longitudinal axis of the crankshaft 2 is suitably spaced apart from the central axis of the working piston 7.

The connecting rods 21, 27, respectively, are anchored in the area of the central longitudinal axis of the working piston 7 and/or the compression piston 5. The rotational axis 25 of the cross connecting rod 24 is located in vertical direction between the rotational axis of the first hinge 23 and the rotational axis of the second hinge 26.

Schematically, it can be seen that an eccentric mounting of cross connecting rod 24 can be provided so as to facilitate the movement of the working piston 5, 7 with very little frictional in the cylinders 4, 6. The eccentric arrangement of bearings has an impact on the position of the two connecting rods 21, 27, which are hinged to the pistons 5, 7 or the bearing can be moved in its position by means of a servo-motor. The cross connecting rod 24 can be mounted eccentrically on a rotating shaft. It is also possible that widely spaced apart positions are specified, where the cross connecting rod 24 can be mounted centrally or eccentrically. The bearing fixed on the axis of revolution 25 of the cross connecting rod 24 can be arranged on a bolt, a stepwise adjustable bolt or a revolving shaft, which can also be mounted eccentrically.

According to FIG. 1, the cylinders 5, 7 can be arranged inclined to the vertical motor axis. Here, a positive or negative slope of the motor axis can be present. Basically, the cylinders 5, 7 can also be arranged parallel to one another.

With reference to FIG. 1, the compression piston 5 can be arranged on the right side of the working piston 7, in the same arrangement of the longitudinal axis 2 of the crankshaft 2. In principle, other arrangements of pistons to crankshaft 5, 7 are beneficial and possible.

Incidentally, the link rod 20 may also be formed of more than two connecting rods 21, 22. More connecting rods can be provided so as to reach a desired reduction of friction losses during upward and downward movement of the piston 5, 7 inside the cylinders 4, 6.

The compression cylinder 4 and the working cylinder 6 can be of different cylinder volumes with respect to the cylinder volume between the top dead center and bottom dead center of the compression piston 5 and/or the working piston 7. Here, the same or different cylinder geometries are possible. For example, pistons 5, 7 can be combined with a round cross-sectional shape with pistons 5, 7 with an oval cross-sectional shape. The illustrated internal combustion engine 1 can be operated with turbo-charging or supercharging.

A change in cylinder volume can also be reached by a change in the length of cross connecting rod 24 or the arrangement of the axis of revolution 25 of the 24 cross connecting rod, which results in a change of the compression stroke of the working piston 5.

In a certain symmetrical arrangement of the working pistons 5, 7, and the arrangements of longitudinal axis 2 of the crankshaft and the axis of revolution 25 of the cross connecting rod 24 (not shown), it is possible, in principle, to link a further connecting rod, which is not shown in detail, to the crank arm 3, on the one hand, and to the second hinge 26, on the other. This would facilitate a connection between the crankshaft, the cross connecting rod 24 and the third connecting rod 27. The other rod must not be anchored on the same crank pin like the connecting rod 22.

The length ratios of the connecting rods 21, 22 and 27 and of the cross connecting rod 24 are not limited to the ratios as shown in FIG. 1.

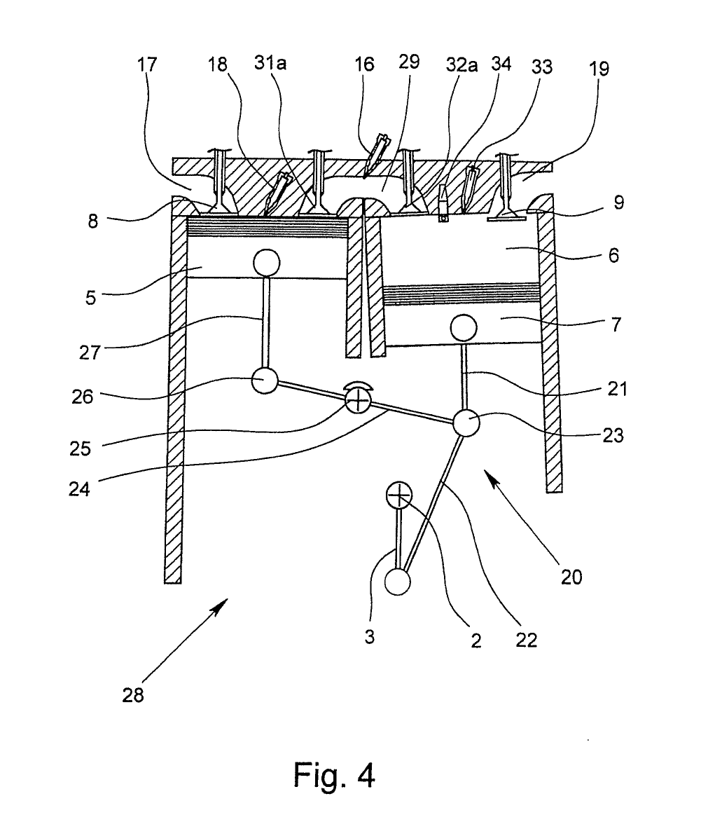

FIGS. 4 to 6 show alternate embodiments of internal combustion engines 28, wherein the components matching the internal combustion engine 1, as shown and described in FIGS. 1 to 3, have been provided with the same reference characters. Only the differences between internal combustion engines 1 and 28 are described in the following.

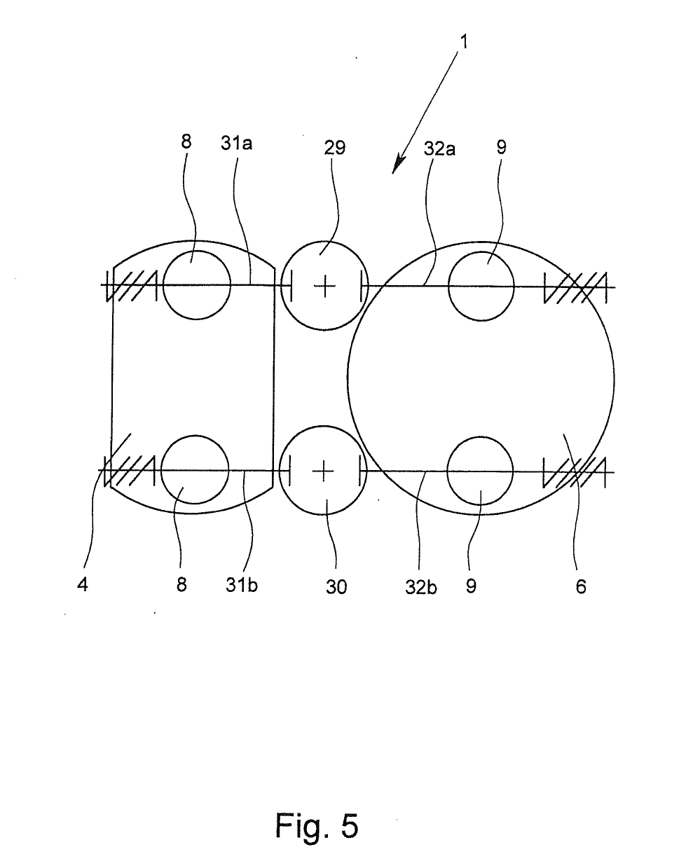

The internal combustion engine 28 has, in the place of combustion chambers, at least two compression chambers 29, 30 separated from each other and interconnecting the compression cylinder 4 and the working cylinder 6, which according to FIG. 5 can have the same volumes. The compression chambers 29, 30 are provided for compressing of air, or for compressing a fuel-air mixture, wherein the ignition and combustion of the fuel-air mixture can take place in the embodiment of the working cylinder 6 as shown in FIG. 4.

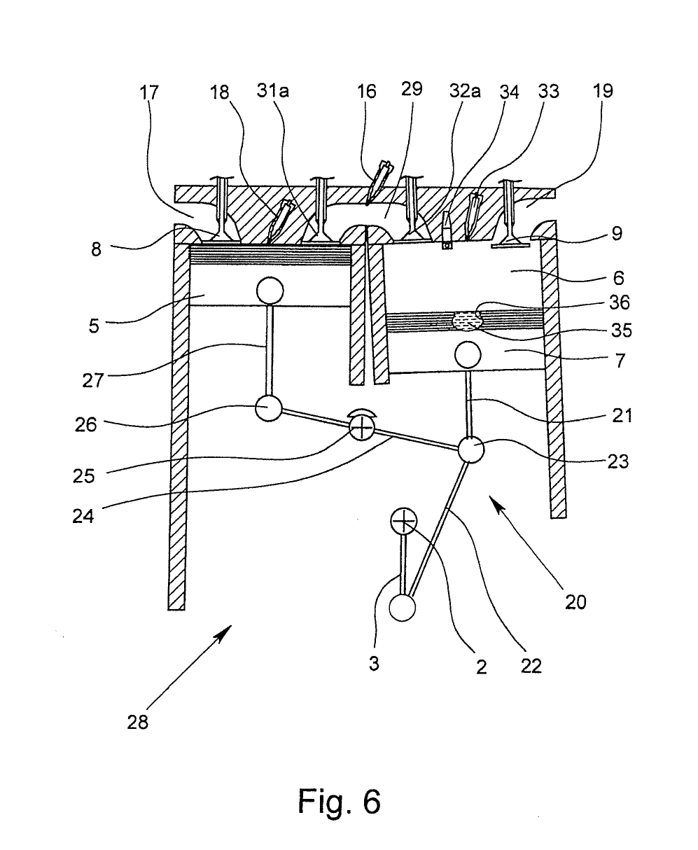

Each compression chamber 29, 30 is connected via at least one compression chamber inlet valve 31a, 31b with the compression cylinder 4 and via at least one compression chamber outlet valve 32a, 32b with the working cylinder 6. The valves 8, 31a, 31b, 32a, 32b, 9 are controlled such that the compression chambers 29, 30 are alternately actuated for compression. In the case of the internal combustion engines 28 as shown in FIGS. 4 and 6, the valves 8, 31a, 31b, 32a, 32b, 9 are arranged essentially parallel to the longitudinal axis of the working cylinder 4 and/or the compression cylinder 6. In the embodiment shown in FIG. 5, the compression chamber inlet valves 31a, 31b and the compression chamber outlet valves 32a, 32b are arranged perpendicular to the longitudinal axis of each cylinder. Further it is understood that in principle, more than two compression chambers 29, 30 may be provided. The compression chambers can be of different sizes, as illustrated for the combustion chambers 10-13 in FIG. 2.

The functioning of the internal combustion engine 28 as shown in FIG. 4, 28 is described below. Air is drawn-in through the open inlet valve 8 during downward movement of the compression piston 5 in the compression cylinder 4. At the bottom dead center of the compression piston 5, the inlet valves 8 close and the compression chamber inlet valve 31a of the first compression chamber 29 opens. During an upward movement of the compression piston 5, the air drawn in the first compression chamber 29 is compressed, in which the compression chamber outlet valve 32a is closed. When the compression piston 5 reaches the top dead center, the first compression chamber inlet valve 31a closes. The working piston 7 about now starts travelling to the top and pushes the stress-relieved gases from the open outlet valves 9 through the outlet valve channel 19 in the exhaust.

The compression piston 5 now again reaches approximately bottom dead center in the compression cylinder 4 and the air is drawn-in through the open inlet valve 8. The working piston 7 is now located close to a position at 360° of the crankshaft revolution.

If diesel or bio-diesel is used as fuel, then the compressed air is prepared for combustion, in which the fuel from the first compression chamber 29 is introduced into the working cylinder 6 through the now open outlet valve 32a of the compression chamber. After closing the compression chamber outlet valve 32a, fuel is injected. Thanks to the high pressure, fuel in the cylinder 6 is brought to combustion by self-ignition. If gasoline, gas, hydrogen or alcohol is used as fuel, then the air for combustion is prepared by direct injection, by guiding it through the open outlet valve 32a of the compression chamber into the working cylinder 6. After closing the compression chamber outlet valve 32a, fuel is injected through a nozzle 33 and then brought to combustion with a spark plug 34.

Enriching the air can also be performed in the suction pipe or the intake port 17 of the cylinder head. Upon enrichment, the compressed mixture present in the first compression chamber 29 is introduced through the open outlet valve 32a of the compression chamber into the working cylinder 6 and brought to combustion after closing the compression chamber outlet valve 32a by means of ignition spark plug 34. Air can also be enriched in the compression cylinder through the nozzle 18. Thereafter, the compressed mixture present in the compression chamber 29 is again passed through the open outlet valve 32a of the compression chamber into the working cylinder 6, and brought to combustion by means of spark ignition upon closing the compression chamber outlet valve 32a. Finally, the enrichment of air can take place partly in the suction pipe or inlet channel 17 in the cylinder head, in the compression cylinder 4 through the nozzle 18 and/or in the compression chamber 29 through the nozzle 16. It is understood that the second compression chamber 30 can have a corresponding nozzle 16. Thereafter, the compressed mixture present in the first the compression chamber 29 is passed through the open outlet valve 32a of the compression chamber into the working cylinder 6 and brought to combustion by means of spark ignition upon closing the compression chamber outlet valve 32a.

Post ignition, working piston 7 is moved back downward and presses the compression piston 5 located in the compression cylinder 4 upwards by means of cross connecting rods 24. The compression piston 5 pushes the air through the open compression chamber inlet valve 31b into the second compression chamber 30.

Once the compression piston 5 has reached the top dead center, the working piston 7 is located in the bottom dead center, which means that the combustion chamber outlet valve 32a closes. Thereafter, the working piston 7 compresses the stress-relieved, burned mixture through the open outlet valve 9 through the outlet valve channel 19 of the cylinder head into the exhaust. At the same time, the compression piston 5 moves to the bottom dead center and draws-in air through the open inlet valves 8. When the working piston 7 reaches a crankshaft revolution just before the notch at 360°, the outlet valves 9 are closed and the pressure present in the second compression chamber 30 is passed through the compression chamber outlet valve 32b in the working cylinder 6 above the working piston 7. Now, as before, it is processed as described further, with reference to the second compression chamber 30.

When using diesel or bio-oil as fuel, optionally, valves 31a, 31b, 32a, 32b of the compression chambers 29, 30 are arranged essentially perpendicular to the respective cylinder axis.

In the internal combustion engine 28 shown in FIG. 6, a vase-shaped combustion chamber 35 is preferably provided in the working piston 7. The combustion chamber 35 is so arranged in the working piston 7 and has a cross-sectional geometry such that air emanating from the combustion of fuel from the respective compression chamber 29, 30 is guided to the combustion chamber 35 such that a rotational flow and/or a swirl of the incoming air is formed, thereafter fuel is injected in its middle range. This requires an appropriate geometry of the combustion chamber 35, which is preferably formed in the shape of a vase as shown in the illustrated embodiment. From the respective compression chamber 29, 30, the outgoing air meets the inner wall 36 of the combustion chamber 35 and is deflected thereby, so that there is a revolving wall flow in the combustion chamber 35. It results in a directed emission of air from the respective compression chamber 29, 30 toward the inner side wall surfaces of the combustion chamber 35 in the upper region of the sidewall surfaces. It is understood that deviating from the embodiment as shown schematically in FIG. 6, the outlet valve of each compression chamber 29, 30 can be aligned to the combustion chamber 35 and can have a suitably adapted outlet geometry.

In the combustion chamber 35 of the working piston 7, still hot residual gases are found after combustion of the fuel and compression of the burned gases. During subsequent inflow of fresh gases from the respective compression chamber 29, 30 for the next combustion process, these residual gases are cooled. This cooling is slowed down by the formation of a rotational flow at the inner wall 36 of the combustion chamber 35. Especially when operating the internal combustion engine 28 with diesel fuel, the colder air-gas mass, not required for combustion, is compressed by the rotational flow formed outside and thus prevent a rapid cooling of the gases and/or the burned mixture at the working piston 7. The colder air-gas mass, not required for combustion, form on the inner wall 36 of the combustion chamber 35 an air cushion that acts as insulation. Thus, pressure reduction in the working cylinder 6 is reduced. It is understood that the combustion chamber 35 is only schematically shown in FIG. 6. The combustion chamber 35 can be arranged further adjacent to the outlet valve of the compression chamber 29, 30. In principle, the combustion chamber 35 may also have a further cross-sectional shape, which favors the formation of a rotational flow at the inner wall 36 of the combustion chamber 35. Further, a plurality of combustion chambers 35 can be provided, wherein each combustion chamber 35 is spatially assigned a certain compression chamber 29, 30.

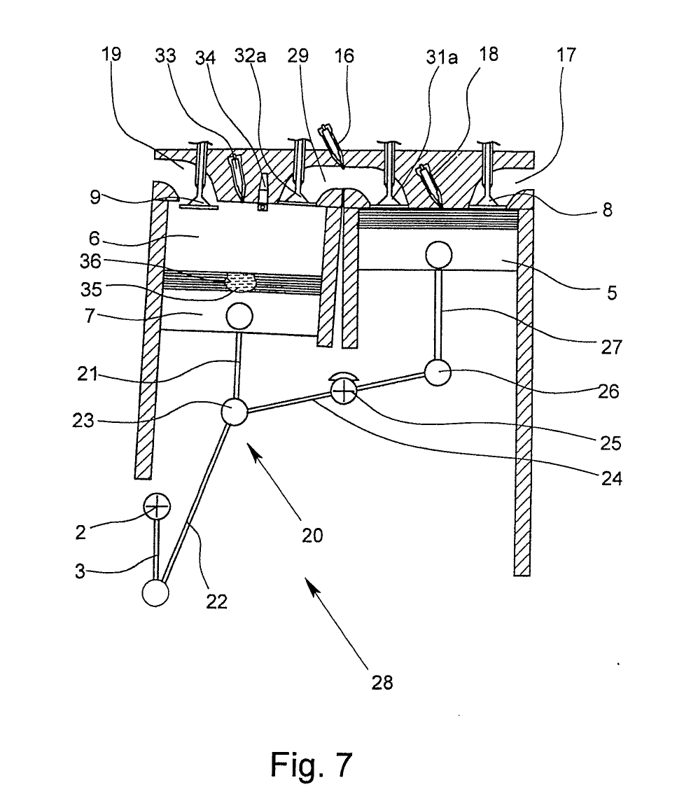

FIG. 7 shows a fifth embodiment of an internal combustion engine 28, which essentially corresponds to the embodiment shown in FIG. 6, but in mirrored arrangement of compression piston 5 and working piston 7, which necessitates a different arrangement of the connecting rods for kinematic coupling of the working pistons 5, 7.

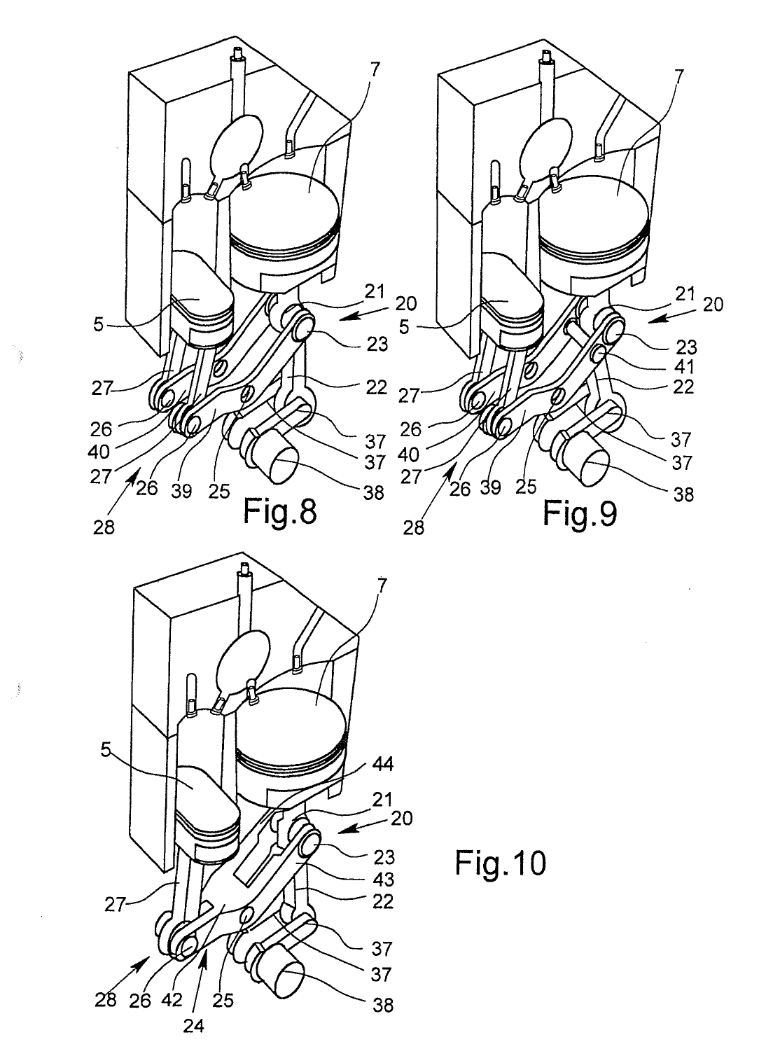

FIGS. 8 to 10 show further embodiments of internal combustion engines 28, wherein the working piston 7 is connected via a hinge to a multi-part link rod 20 with the crankshaft. The link rod 20 has in turn two connecting rods 21, 22, wherein the connecting rods 21, 22 are connected together at their ends by at least one first hinge (pivot pin) 23. The other end of a first connecting rod 21 is pivotably connected to the working piston 7 and the other end of a second connecting rod 22 is pivotably connected with two pivot pins 37, which receive the second connecting rod 22 and during operation, describe a circular path around the rotational axis of the crankshaft. The pivot pins 37 are connected to a shaft journal 38 of the crankshaft.

In the area of the first hinge 23, FIG. 8 shows two connecting rods 39, 40 that are parallel, but spaced apart from each other and pivotably connected at their ends to the connecting rods 21, 22. The connecting rods 39, 40 are swivel-mounted in the form of a rocker about a rotational axis 25. In the case of the embodiments as shown in FIGS. 8 and 9, the connecting rods 39, 40 form a cross connecting rod, through which, the movements of the working piston 7 and compression pistons 5 are coupled.

At the other end, each connecting rod 39, 40 is connected via at least one second hinge 26 with a third connecting rod 27. The third connecting rod 27 is pivotably connected to the compression piston 5.

As is clear from FIGS. 8 and 9, the distance between the connecting rods 39, 40 are chosen to be large so that a back-swing of the crank pins 37 is possible. Thus, the revolution axis 25 can be arranged closer to the rotational axis of the crankshaft, which has a beneficial effect on the efficiency of fuel combustion and restricts a lower overall height.

In the embodiment shown in FIG. 9, the second connecting rod 22 is connected via a second pivot joint 41 with the connecting rods 39, 40. The first connecting rod 21 is connected via the first pivot joint 23 with the connecting rods 39, 40. The connecting rods 21, 22 need not, therefore, be connected via a hinge joint with the cross connecting rod, which can also apply to the above-described embodiments of internal combustion engines 1, 28.

In the embodiment shown in FIG. 10, the cross connecting rod 24 has a first rocker arm 42 pivotably connected with a third connecting rod 27, which pivots about the rotational axis 25. At the other end, the cross connecting rod 24 has two mutually parallel flanks 43, 44, which receive both of the connecting rods 21, 22 and are hinged to the connecting rods 21, 22.

What is claimed is:

1-28. (canceled)

29. Internal combustion engine, comprising:
a crankshaft,
at least one compression cylinder having at least one inlet valve for drawing-in air into the at least one compression cylinder,
at least one compression piston mounted for movement in said at least one compression cylinder,
at least one working cylinder having at least one outlet valve for emitting combustion gases from the at least one working cylinder,
at least one working piston mounted for movement in said at least one working cylinder,
wherein the at least one compression piston and at least one working piston are connected by kinematic coupling thereof to movement of the crankshaft in a manner causing the at least one compression piston to move back and forth executing an intake stroke and a compression stroke of a four-stroke cycle during a single rotation of the crankshaft and causing the at least one working piston to move back and forth executing a working stroke and an exhaust stroke during the same single rotation of the crankshaft,
wherein said at least one inlet valve draws-in air into the compression cylinder during a downward movement of the compression piston and said at least one outlet valve discharges combustion gases during an upward movement of the working piston,
wherein said kinematic coupling comprises a multi-part link rod connecting the working piston with the crankshaft, the link rod comprising at least two connecting rods connected at proximal ends thereof to at least a first pivot joint, a distal end of a first of said connecting rods being hinged to the working piston and a distal end of a second of said connecting rods being pivotably connected to the crankshaft, and wherein said kinematic coupling further comprises a cross connecting rod that is hinged to the first pivot joint at on end, is pivotably mounted in the manner of a rocker arm about a pivot axis, and is pivotably mounted via at least a second pivot joint with at least a third connecting rod, the third connecting rod being pivotably connected with the compression piston.

30. Internal combustion engine according to claim 29, wherein a longitudinal axis of the crankshaft runs in a vertical direction below axis of rotation of the first rotary joint and below an axis of rotation of the second rotary joint.

31. Internal combustion engine according to claim 29, wherein a longitudinal axis of the crankshaft runs in a vertical direction below an axis of rotation of the cross connecting rod.

32. Internal combustion engine according to claim 29, wherein a longitudinal axis of the crankshaft runs in a horizontal direction laterally spaced apart from an axis of rotational of the first rotary joint in an area between an axis of rotation of the first rotary joint and an axis of rotation of the second rotary joint.

33. Internal combustion engine according to claim 29, wherein the longitudinal axis of the crankshaft runs in a horizontal direction in an area between a rotation axis of the cross connecting rod and an axis of rotation of the first rotary joint.

34. Internal combustion engine according to claim 29, wherein the longitudinal axis of the crankshaft is spaced apart in a horizontal direction from a central axis of the working piston.

35. Internal combustion engine according to claim 29, wherein the first connecting rod is hinged in an area of the central longitudinal axis of the working piston to the working piston and the second connecting rod is hinged in an area of the central longitudinal axis of the compression piston to the compression piston.

36. Internal combustion engine according to claim 29, wherein the cross connecting rod is mounted eccentrically.

37. Internal combustion engine according to claim 29, wherein the at least one compression cylinder and the at least one working cylinder are arranged inclined relative to each other and to a vertical motor axis.

38. Internal combustion engine according to claim 29, wherein the at least one compression cylinder and the at least one working cylinder have different cylinder volumes with respect to the cylinder volume between the top dead center and bottom dead center of the working piston.

39. Internal combustion engine according to claim 29, wherein the at least one compression cylinder has a different cross-sectional geometry from that of the at least one working cylinder.

40. Internal combustion engine according to claim 29, wherein a fourth connecting rod is provided pivotably connected between the crankshaft and the second rotary joint of the cross connecting rod.

41. Internal combustion engine according to claim 29, further comprising at least two compression chambers for compressing air or a fuel-air mixture, said at least two compression chambers being separated from each other and interconnecting the at least one compression cylinder with the at least one working cylinder,
wherein ignition and combustion of a fuel-air mixture takes place in the working cylinder,
wherein each compression chamber is connected via at least one compression chamber inlet valve with a respective compression cylinder and via at least one compression chamber outlet valve with a respective working cylinder, and wherein the valves are controlled such that the compression chambers are controlled alternately for compression.

42. Internal combustion engine according to claim 41, wherein the control of the valves enables opening of the compression chamber outlet valve for rotation of the crankshaft by more than 340° to 360° and wherein the crankshaft is adapted to bring the working piston a top dead center position upon rotation thereof by 360°.

43. Internal combustion engine according to claim 41, wherein the compression chambers are of identical size.

44. Internal combustion engine according to claims 41, wherein said at least two compression chambers form a compression chamber pair, wherein at least two compression chamber pairs are provided, each of which has compression chambers of equal size, wherein the compression chambers of a first of the compression chamber pairs are greater than the compression chambers of a second of the compression chamber pairs, and wherein the compression chambers of a compression chamber pair are alternately controlled for compression.

45. Internal combustion engine according to claims 41, wherein said at least two compression chambers form a compression chamber pair, wherein at least two compression chamber pairs are provided, each of which has compression chambers of different size, wherein both the compression chambers of a compression chamber pair are jointly controllable for compression and wherein the compression chamber pairs are controlled alternately.

46. Internal combustion engine according to claim 29, further comprising at least two compression chambers for compressing air or a fuel-air mixture, said at least two compression chambers being separated from each other and interconnecting the at least one compression cylinder with the at least one working cylinder,
wherein in the working piston is provided with an ignition and burning chamber in an end face thereof,
wherein each compression chamber inlet is connected via at least one compression chamber inlet valve with a respective compression cylinder and wherein each compression chamber outlet is connected via at least one compression chamber outlet valve with a respective working cylinder, and
wherein the compression chamber outlet is aligned relative to the ignition and burning chamber of the respective working cylinder in such a manner that, in conjunction with a cross-sectional geometry of the ignition and burning chamber, compressed air or a compressed fuel-air mixture emanating from the compression chamber will flow into the the ignition and burning chamber and be deflected at an inner wall thereof so as to form a rotational flow.

47. Internal combustion engine according to claim 29, wherein at least one device is provided for injecting of at least one of water, alcohol and a mixture of water and alcohol into the compression cylinder.

48. Internal combustion engine according to claim 29 further comprising at least two compression chambers for compressing air or a fuel-air mixture, said at least two compression chambers being separated from each other and interconnecting the at least one compression cylinder with the at least one working cylinder,
wherein each compression chamber inlet is connected via at least one compression chamber inlet valve with a respective compression cylinder and wherein each compression chamber outlet is connected via at least one compression chamber outlet valve with a respective working cylinder, and
wherein the combustion chamber outlet valve is controlled to open after combustion in the combustion chamber and wherein the combustion chambers are alternately controlled for combustion.

49. Internal combustion engine according to claim 48, wherein the combustion chambers have an identical size.

50. Internal combustion engine according to claims 48, wherein said at least two compression chambers form a compression chamber pair, wherein at least two compression chamber pairs are provided, each of which has compression chambers of equal size, wherein the compression chambers of a first of the compression chamber pairs are greater than the compression chambers of a second of the compression chamber pairs, and wherein the compression chambers of a compression chamber pair are alternately controlled for compression.

51. Internal combustion engine according to claims 48, wherein said at least two compression chambers form a compression chamber pair, wherein at least two compression chamber pairs are provided, each of which has compression chambers of different size, wherein both of the compression chambers of a compression chamber pair are jointly controllable for compression and wherein the compression chamber pairs are controlled alternately.

52. Internal combustion engine according to claim 51, wherein the compression chambers of different size of a combustion chamber pair have a total combustion chamber volume corresponding to a maximum cylinder filling volume of the working cylinder.

53. Internal combustion engine according to claim 51, wherein the combustion chamber volume of the larger of the combustion chambers of different size is approximately twice as large as the combustion chamber volume of the smaller of the combustion chambers of different size.

54. Internal combustion engine according to claim 48, wherein the combustion chamber outlet valve is controlled to provide opening of the combustion chamber outlet valve during rotation of the crankshaft by less than 20° beyond a top dead center position of the working piston.

55. Internal combustion engine according to claim 48, wherein the compression piston and the working piston execute a counter-movement between the respective top dead center and bottom dead center positions.

56. Internal combustion engine according to claim 48, wherein the compression cylinder and the working cylinder are arranged side by side in a plane transverse to a longitudinal axis of the crankshaft.
